(19) United States
(12) Patent Application Publication
(10) Pub. No.: US 2014/0234514 A1
(43) Pub. Date: Aug. 21, 2014

(54) METHOD FOR MAKING FOAMY BEVERAGES CONTAINING LIPIDS, AND RELATED COMPOSITION

(71) Applicant: Steven FINLEY, Wayne, NJ (US)

(72) Inventor: Steven FINLEY, Wayne, NJ (US)

(21) Appl. No.: 13/771,114

(22) Filed: Feb. 20, 2013

(51) Int. Cl. A23L 2/54

(52) U.S. Cl. CPC A23L 2/54
USPC 426/569; 426/474; 426/394

(57) ABSTRACT

A method of making a foamy beverage includes providing a liquid having at least one lipid-based ingredient therein and adding argon (Ar) gas to the liquid to provide a mixture for the foamy beverage. A beverage is also provided and includes a liquid mixture having at least one lipid-based ingredient therein and argon gas mixed into the liquid mixture.

### BACKGROUND

The present embodiments relate to methods for providing beverages with a foamy appearance and a creamy mouthfeel, and related compositions.

Methods are known for preparing foam for carbonated beverages which contain dairy and/or hydrocolloidal compositions. Some of these methods include mixing carbon dioxide (CO₂) and nitrous oxide (N₂O) usually ranging from 25% CO₂/75% N₂O to 75% CO₂/25% N₂O to create such a foamy beverage.

Other methods are known for creating a foamy beverage containing milk by injecting N₂O or other gases, such as Hydrofluorocarbons (HFC) or Hydrochlorofluorocarbons (HCFC), into the beverage.

It is also known that N₂O is a desirable gas because of its solubility in lipids, such that the N₂O can be injected into dairy products to produce a foaming effect in such products. An example of N₂O in food products is its use in whipped cream. During the process for producing the whipped cream, N₂O is mixed with heavy cream under pressure and under those conditions, a significant amount of the gas can be added under pressure to the cream forming small bubbles within the mixture. While under pressure, the gas-cream mixture remains stable and in fact, N₂O provides protection against spoilage due to microorganism activity. As a result, whipped cream stored with N₂O has a longer shelf life than whipped cream stored alone.

The foregoing preservation effective N₂O works well with a full range of lipids or fat-based products, beyond just dairy products. For example, N₂O can also be used as a propellant gas for spray-type vegetable oil products. In addition to the preservation benefits of N₂O, oxygen is also displaced by N₂O, thereby protecting the oil from becoming rancid.

When a cream nitrous oxide mixture is dispensed from the pressurized container holding same, the pressure of the mixture is reduced considerably, including the pressure on fine bubbles of N₂O dispersed in the cream. As a result of the pressure reduction, the fine bubbles in the mixture expand, which results in the volume of the mixture increasing substantially. Such is the effect witnessed when the whipped cream is dispensed from its container.

However, in addition to the benefits offered by N₂O, there are some disadvantages that the chemical compound has and which are of concern, in particular to manufacturers of food products. For example, N₂O produces an analgesic effect when inhaled. There are recorded examples of recreational use of N₂O resulting in serious injury and in some instances death by asphyxiation as a result of abuse by persons unfamiliar with proper use and the associate risks of N₂O. N₂O is a strong greenhouse gas having global warming potentials (GWP) in excess of 20 times that of carbon dioxide (CO₂). With HFCs and HCFC, the GWP can be greater than 1,000 and even higher than 10,000 for some compounds. Such compounds may also contribute to depletion of the ozone layer and are heavily regulated as a result of these properties. The State of California has regulated N₂O due to its link to harmful effects that may be caused to the human reproductive system from improper use of N₂O. In California, N₂O is listed as a harmful substance, and food manufacturers are required by law to label a product with a notice that the product contains ingredients which may be harmful.

Although N₂O is very effective as an agent for modifying the texture and mouthful of beverages and providing a preservation to certain products, it has certain disadvantages and therefore, for food producers in particular, an alternative ingredient would be desirable.

### SUMMARY OF THE INVENTION

A method of making a foamy beverage includes providing a liquid having at least one lipid-based ingredient therein and adding argon gas to said liquid to provide the foamy beverage.

A beverage having a foamy composition and creamy mouthfeel includes a liquid mixture having at least one lipid-based ingredient therein and argon gas mixed into the liquid mixture.

### BRIEF DESCRIPTION OF THE DRAWINGS

For a more complete understanding of the present embodiments, reference may be had to the following description taken in conjunction with the drawing Figures, of which:

FIG. 1 shows a flowchart for a first embodiment of a method according to the present invention; and

FIG. 2 shows a flowchart of another embodiment of a method according to the present invention.

### DETAILED DESCRIPTION OF THE INVENTION

This invention is a method for making a foamy beverage by mixing a lipid-containing liquid or beverage with gaseous argon (Ar) to improve the appearance and provide a creamy mouth-feel of the beverage. A foamy beverage containing argon is also provided. Reference herein to “argon” means “argon gas”, unless otherwise indicated.

The benefits of argon are similar to those found in nitrous oxide, but without the adverse consequences associated with nitrous oxide. The specific effect achieved by injecting argon gas into lipid-containing beverages is the modification of the appearance, texture and mouth-feel of those beverages.

The present embodiments provide a method to improve the appearance and mouth feel of beverages which contain fats and/or oils in such compositions. The beverage may be for example a fruit or vegetable juice of any flavour or combination of fruit and vegetable juices, a liquid with a flavoured syrup, or milk from coconut, soy or almond. In the beverages, use of the present method will provide a thick, foamy, creamy head. The base liquid for the beverage does not have to be carbonated.

The present embodiments call for preparation of the beverage by having argon gas mixed with a particular liquid or beverage. An amount of argon to be mixed with the beverage is determined by the amount of lipid-based ingredients in the beverage, for example, a ratio of dairy to the water-based components. Further, the quantity of argon to be mixed into the beverage is determined by the desired effect, specifically, the desired increase in volume and consistency of the head or foam to be produced in the beverage.

The quantity of argon gas that can be mixed into the liquid is a function of the temperature and the pressure of the liquid. Generally, increasing the pressure of the mixture with the argon or increasing the pressure of the liquid as the argon is being added permits the beverage to contain an increased amount of the argon gas. The addition of the argon gas to the beverage is itself sufficient to also increase the pressure of the mixture to thereby permit an increase in the amount of argon that can be contained in the beverage. This occurs when, for example, the argon gas is injected into the liquid or existing mixture. The pressure range for mixing the argon into the mixture may be from 1 to 10 barg (14.5 to 145 psig) by way of example only. When the temperature of the mixture or beverage is decreased, the mixture's capacity to contain argon is increased as well. The temperature range for which the argon is to be mixed with the beverage may be from 0° to 10° C. (32° to 50° F.) by way of example only.

The amount of argon gas added to the lipid-containing beverage will solubilise with the lipid-containing portion of the beverage and the water in the beverage. However, it is that portion of the argon gas dissolved in the lipid portion of the beverage that produces the foamy, creamy effect of the beverage. The argon is dissolved and comes out of solution as a gas to create a foam for the beverage. This enhances the appearance and the mouth feel of non-carbonated beverages that contain a significant amount of lipid-based ingredients, such as for example dairy based beverages.

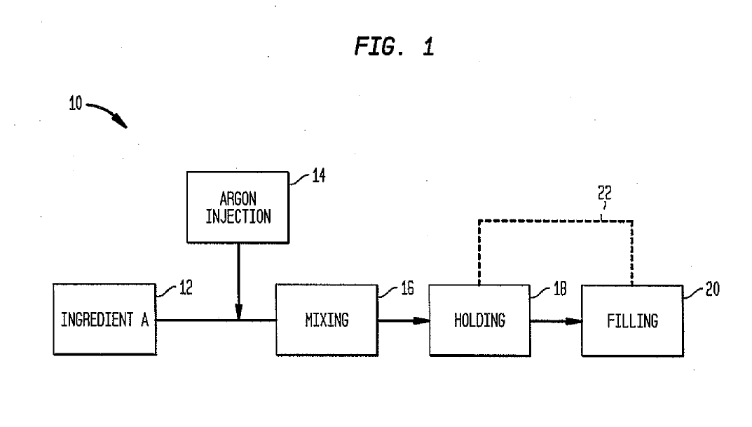

Referring to FIG. 1, an embodiment of a flowchart for the present method is shown generally at 10, and includes providing an ingredient “A” 12 into which argon is added 14, by injection for example, to provide a mixture, after which the ingredient 12 and the argon may be mixed 16 and then held 18 in a holding station or storage tank. From there, a filling step for the beverage mixture containing the argon will be used to fill containers. A pressure balance 22 is maintained between the holding 18 and the filling 20 so that the beverage mixture does not unintentionally expand prior to being filled into containers for consumption.

Still referring to FIG. 1, the argon 14 provided to the ingredient 12 may create turbulence sufficient enough that the mixing step 16 does not have to be used and the resulting beverage containing the ingredient 12 mixed with the argon gas 14 can be provided immediately to the station or tank 18 for holding.

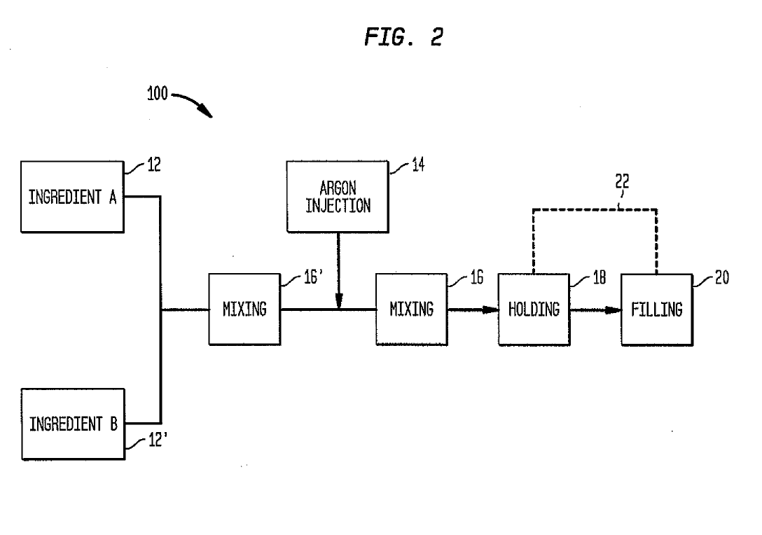

Referring now to FIG. 2, in another embodiment shown generally at 100, an ingredient “B” 12′ is additionally added with the ingredient 12. The ingredients 12,12′ are mixed at the mixing station 16′ prior to providing the argon 14 into the ingredient mixture. The argon gas 14 provided may be injected into the mixture to facilitate dissolving the argon in the mixture. Similar to that which occurred above with respect to the method embodiment of FIG. 1, after the argon 14 is provided into the mixture, the mixture can again be mixed at the station 16 prior to being delivered to the holding station or tank for holding. Alternatively, if the argon injection 14 is of a turbulence sufficient to mix the argon into the ingredients 12,12′, then the mixing step 16 does not have to employed and the mixture can proceed immediately to the holding station or tank. In FIG. 2, since there are ingredients A,B (12,12′, respectively), at least one of the ingredients 12,12′ would have a lipid-based ingredient therein, or alternatively both can have the ingredient. The pressure balance 22 is maintained between the holding 18 and the filling 20 so that the beverage mixture does not unintentionally expand prior to being filled into containers for consumption.

With respect to both the FIGS. 1 and 2, providing the argon gas 14 to the mixture should be at a pressure sufficient to mix the argon with the ingredients 12,12′. In addition, the pressure balance 22 is applied to the holding tank or station to maintain the argon to be mixed with the ingredients 12,12′. As with FIG. 1, the pressure balance 22 is maintained between the holding 18 and the filling 20 so that the beverage mixture does not unintentionally expand prior to being filled into the individual containers for later being discharged and consumed. The ingredients 12,12′ can be syrup, coffee, juice, fruit-dairy mixtures, chocolate-dairy mixtures, cow milk, goat milk, soy milk, almond milk and coconut milk.

The following examples are with respect to the embodiments of the present invention.

### EXAMPLE 1

In a first representative embodiment, argon gas is mixed with a liquid ingredient or beverage containing lipids using known equipment, such as equipment used in the soft drink industry for carbonation. The water and lipid components of the beverage are de-aerated to displace dissolved oxygen in the beverage, i.e. more specifically displace oxygen and nitrogen from the beverage prior to the addition of the argon gas. A temperature controlled pressure vessel with gas dissolution device including venturi-type gas injectors, porous stone or metal spargers, spray mixtures, agitators or trays can be used to increase the exposed surface area of the beverage to the argon gas when mixing the gas into the beverage. When the argon is mixed with the beverage, the mixture is maintained under pressure to maintain the gas-beverage mixture. If the pressure is reduced, which is likely to occur just prior to consuming the beverage, the smaller bubbles that are captive in the mixture will expand, thereby producing the desired effect of a foamy, creamy head which can last for up to 30 minutes.

### EXAMPLE 2

In still another embodiment, argon gas is mixed with a beverage containing lipids, the mixing being done with a carbonator device; typically used to dissolve CO₂ into beverages that do not contain lipids.

The argon gas can be provided from a source such as a pressurized tank or cylinder (not shown). Even if the argon is under pressure as a liquid in the tank, upon release, the liquid argon will expand and phase to a gas, vapor or atomized jet or stream.

It has been discovered that argon gas exhibits considerably higher solubility in lipid-containing beverages, compared with many other gases. Injecting argon under pressure into a lipid-based beverage produces a thicker consistency and a creamy head on the beverage.

### EXAMPLE 3

This experiment resulted in an increase in volume (volume at atmospheric pressure divided by volume at high pressure) of 18.8% when the beverage was injected with pure argon gas at a pressure of 72 psig. For comparison purposes, a benchmark test using nitrogen under similar conditions resulted in expansion of only 4.9%. In this experiment, argon gas was injected into whole milk using a porous sintered metal sparger into a tube used to transfer the mild to a holding tank. The holding tank was maintained under pressure (72 psig) in a vessel pressurized with gaseous nitrous oxide. The treated milk was dispensed under pressure into a 2 liter polyethylene terephthalate (PET) plastic beverage bottle. To determine the rate of expansion, the pressure in the PET bottle was reduced to atmospheric pressure to simulate the action of a consumer opening the bottle prior to consumption. The volume of the treated milk was measured under pressure again after the pressure was released. The volume of milk under pressure was 1430 ml, which increased to 1690 ml after the pressure was released. The calculated result was an 18.8% expansion.

Argon does not react with ingredients, because it is an inert gas, thereby preserving the original taste of the beverage. It is also effective in displacing dissolved oxygen from the beverage which provides the added benefit of protecting the beverage from the detrimental effect of oxidation of compounds that are reactive with oxygen. By displacing oxygen, argon also limits spoilage caused by aerobic micro-organisms.

Examples above demonstrated that argon is a highly effective gas for modifying the appearance, texture and mouth-feel for lipid-containing beverages. The amount of argon that can be mixed into a beverage is a function of the temperature and pressure of the beverage during mixing. Effective mixing of argon with lipid-containing beverages can be achieved at a temperature range 33.8° to 42° F. (1° to 5.5° C.). During testing, effective mixing was accomplished when the temperature was 42° F. (5.5° C.). Testing demonstrated that lowering the temperature of the beverage increases the effectiveness of mixing the argon with the liquid for the beverage.

Generally, increasing the pressure of the mixture increases the beverage's capacity for containing argon. The recommended pressure range for mixing argon into the beverage is 4 to 6 Barg (58 to 87 psig).

During the tests, the argon gas was injected using a sintered metal sparger at the temperature and pressure conditions indicated above. During commercial production, more accurate control of temperature and pressure, as well as more effective mixing technologies, can be implemented to improve the effectiveness of argon gas/liquid mixing, including venturi, spray mixing or other gas liquid mixing technologies known in the field.

In comparison to N₂O, argon is a safer ingredient for beverage consumers. In addition, argon does not exhibit the harmful effects to the environment as does N₂O; specifically global warming potential and ozone depletion.

Argon is Generally Recognized as Safe (GRAS) by the U.S. Food and Drug Administration (FDA).

Argon does not carry the risk of the narcotic effect of N₂O. It is undesirable and in certain instances illegal for a beverage brand owner to add to their products an ingredient that is used either medically or recreationally to produce a mind-altering effect.

Devices used to mix the argon gas in the lipid-based ingredient may include a temperature controlled pressure vessel with a gas dissolution device, including venturi-type gas injectors, spray mixers or trays, to increase the exposed surface area of the liquid to the gas.

Once the argon gas is mixed with the beverage, the mixture must be kept under pressure to maintain the gas/liquid mixture. Once the pressure is reduced; preferably just prior to consuming the beverage, the small bubbles that are captive in the mixture will expand; producing the desired effect which will last for up to 30 minutes.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A method of making a foamy beverage, comprising providing a liquid having at least one lipid-based ingredient therein and adding argon gas to said liquid to provide a mixture for the foamy beverage.

2. The method of claim 1, further comprising mixing the liquid and the argon gas.

3. The method of claim 1, further comprising adding the argon gas to the mixture under pressure.

4. The method of claim 2, wherein the mixing is at a temperature of from 1° to 5.5° C. (33.8° to 42° F.).

5. The method of claim 2, wherein the mixing is at a pressure from 4 to 6 Barg (58 to 87 psig).

6. The method of claim 1, further comprising displacing dissolved air in the liquid prior to the mixing of the argon gas with the liquid.

7. The method of claim 3, further comprising maintaining the pressure after the mixing, and reducing the pressure for expanding bubbles in the mixture.

8. The method of claim 1, further comprising packaging the mixture in a container at a first pressure; disposing a pressurized capsule containing another amount of argon gas in the container, the pressurized capsule at a second pressure less than the first pressure and greater than atmospheric pressure; opening the container to discharge the mixture; and rupturing the pressurized capsule for releasing and mixing the another amount of argon gas with the mixture to provide the foamy beverage.

9. The method of claim 1, further comprising decreasing a temperature of the liquid for increasing an amount of the argon gas to be contained in the mixture.

10. The method of claim 1, wherein the liquid is selected from the group consisting of syrup, coffee, juice, fruit-dairy mixtures, chocolate-dairy mixtures, cow milk, goat milk, soy milk, almond milk and coconut milk.

11. The method of claim 1, wherein the at least one lipid-based ingredient is at from 25% to 100%; and the argon gas is at from 0.02% to 0.15% by weight of the foamy beverage.

12. The method of claim 1, further comprising storing the mixture at a select pressure.

13. A beverage having a foamy composition, comprising a liquid mixture having at least one lipid-based ingredient therein and argon gas mixed into the liquid mixture.

14. The beverage of claim 13, wherein the liquid mixture is selected from the group consisting of syrup, coffee, juice, fruit-dairy mixtures, chocolate-dairy mixtures, cow milk, goat milk, soy milk, almond milk and coconut milk.

15. The beverage of claim 13, further comprising a container for holding the liquid mixture at a first pressure; and a capsule with another amount of argon gas contained therein, the capsule disposed in the liquid mixture for holding the another amount of argon gas at a second pressure less than the first pressure and greater than atmospheric pressure.

16. The beverage of claim 13, wherein the at least one lipid-based ingredient comprises at least one ingredient selected from milk, plant oil, other lipid-containing ingredients, and a combination thereof in which the argon gas is dissolved under pressure.

17. The beverage of claim 16, wherein the milk is selected from the group consisting of cow milk, goat milk, soy milk, almond milk and coconut milk.

18. The beverage of claim 13, wherein the at least one lipid-based ingredient is at from 25% to 100%; and the argon gas is at from 0.02% to 0.15% by weight of the beverage.
